(19) United States
(12) Patent Application Publication
(10) Pub. No.: US 2025/0249685 A1
(43) Pub. Date: Aug. 7, 2025

(54) LIQUID EJECTION APPARATUS, MAINTENANCE UNIT, AND MAINTENANCE METHOD FOR LIQUID EJECTION APPARATUS

(71) Applicant: SEIKO EPSON CORPORATION, Tokyo (JP)

(72) Inventors: Chikashi NAKAMURA, AZUMINO-SHI (JP); Satoru KOBAYASHI, SHIOJIRI-SHI (JP)

(21) Appl. No.: 19/044,795

(22) Filed: Feb. 4, 2025

(30) Foreign Application Priority Data
Feb. 7, 2024 (JP) 2024-016910

(51) Int. Cl. B41J 2/165

(52) U.S. Cl. CPC B41J 2/16547; B41J 2/16505; B41J 2/16523; B41J 2/16541; B41J 2002/16594

(57) ABSTRACT

A liquid ejection apparatus including a liquid ejection unit including a nozzle surface in which a nozzle opens, the liquid ejection unit configured to eject liquid from the nozzle, a cap portion configured to receive liquid discharged from the liquid ejection unit, a suction pump configured to suck liquid inside the cap portion, and a wiping unit configured to wipe the nozzle surface by moving in a first direction together with the cap portion and the suction pump.

The present application is based on, and claims priority from JP Application Serial Number 2024-016910, filed Feb. 7, 2024, the disclosure of which is hereby incorporated by reference herein in its entirety.

### BACKGROUND

### 1. Technical Field

The present disclosure relates to a liquid ejection apparatus, a maintenance unit, and a maintenance method for the liquid ejection apparatus.

### 2. Related Art

Typically, there is a known liquid ejection apparatus configured to eject ink onto a medium, the liquid ejection apparatus including a mechanism configured to perform maintenance of a liquid ejection unit (see, for example, JP-A-2020-69676). The apparatus described in JP-A-2020-69676 includes a liquid reception unit configured to receive ink jetted for wiping and flushing a nozzle surface on which a nozzle configured to eject liquid is arranged.

As in the apparatus described in JP-A-2020-69676, when a liquid jet unit is moved for performing wiping after liquid is ejected by the liquid jet unit at the time of maintenance, there is a possibility that the ink adhering to the liquid jet unit scatters. For this reason, it was necessary to take measures such as reducing the speed of movement of the liquid jet unit.

### SUMMARY

One aspect of the present disclosure is a liquid ejection apparatus including a liquid ejection unit including a nozzle surface in which a nozzle opens, the liquid ejection unit configured to eject liquid from the nozzle a cap portion configured to receive liquid discharged from the liquid ejection unit a suction pump configured to suck liquid inside the cap portion, and a wiping unit configured to wipe the nozzle surface by moving in a first direction together with the cap portion and the suction pump.

One aspect of the present disclosure is a maintenance unit configured to maintain a liquid ejection apparatus including a liquid ejection unit including a nozzle surface in which a nozzle opens, the liquid ejection unit configured to eject liquid from the nozzle, the maintenance unit including a cap portion configured to receive liquid discharged from the liquid ejection unit, a suction pump configured to suck liquid inside the cap portion, and a wiping unit configured to wipe the nozzle surface by moving in a first direction together with the cap portion and the suction pump.

One aspect of the present disclosure is a maintenance method for a liquid ejection unit including a nozzle surface in which a nozzle opens, the liquid ejection unit configured to eject liquid from the nozzle, the maintenance method including discharging liquid from the liquid ejection unit to a cap portion configured to receive liquid, wiping, by the wiping unit, the nozzle surface by moving, together with the cap portion, a suction pump configured to suck liquid from the cap portion, and a wiping unit in a first direction, and sucking liquid discharged to the cap portion by the suction pump.

### BRIEF DESCRIPTION OF THE DRAWINGS

FIG. 1 is a perspective view illustrating a configuration of a liquid ejection apparatus as one embodiment of the present disclosure.

FIG. 2 is a bottom view of a main portion including a liquid ejection unit and a carriage.

FIG. 3 is a plan view of a maintenance unit.

FIG. 4 is a side view of the maintenance unit.

FIG. 5 is a side view of the maintenance unit.

FIG. 6 is a side view of the maintenance unit.

FIG. 7 is a block diagram illustrating a configuration of a control system of the liquid ejection apparatus.

FIG. 8 is a flowchart showing an operation of the liquid ejection apparatus.

FIG. 9 is a flowchart showing an operation of the liquid ejection apparatus.

### DESCRIPTION OF EMBODIMENTS

### 1. Configuration of Liquid Ejection Apparatus

A liquid ejection apparatus 11 of the present disclosure will be described below with reference to the drawings.

In each of the drawings, the same reference signs are given to the same members, and redundant description will be omitted. In each drawing, X, Y, and Z represent three spatial axes orthogonal to one another. In the following description, directions along X, Y, and Z axes are an X axis direction, a Y axis direction, and a Z axis direction, respectively. When an orientation is specified, positive and negative signs are used for direction notation with “+” for a positive direction and “−” for a negative direction, and an orientation where an arrow in each drawing is directed is a +direction and an opposite direction to the arrow is a-direction.

The Z axis direction indicates a gravity direction, where a +Z direction indicates a vertically downward direction, and a −Z direction indicates a vertically upward direction. Furthermore, the three spatial axes of X, Y, and Z that are not limited to positive and negative directions will be described as the X axis, Y axis, and Z axis. In the following description, a direction along the X axis is also called a width direction X, a direction along the Y axis is also called a depth direction Y, and a direction along the Z axis is also called a gravity direction Z.

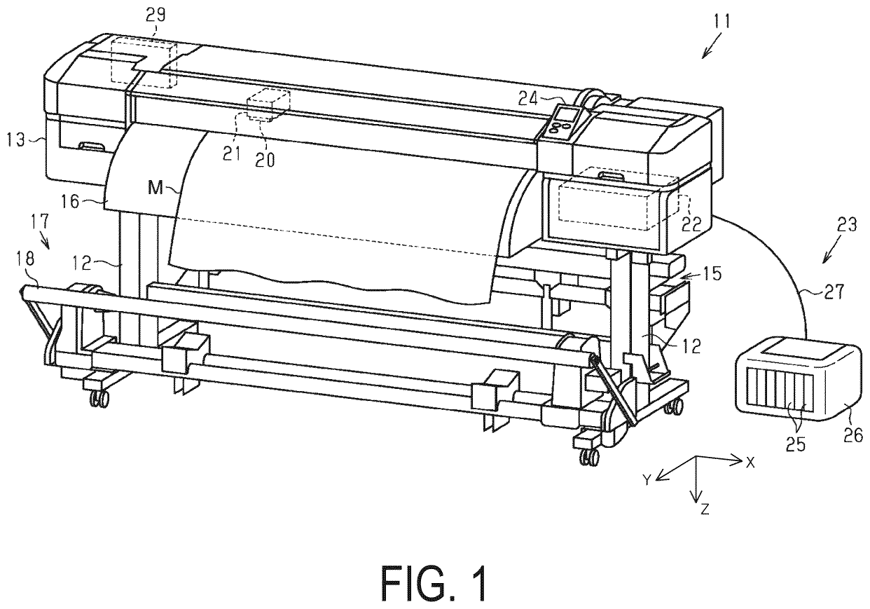

FIG. 1 is a perspective view illustrating the configuration of a liquid ejection apparatus 11 as one embodiment of the present disclosure.

The liquid ejection apparatus 11 is, for example, an inkjet type printer configured to perform printing by ejecting ink, which is an example of liquid, onto a medium M such as paper.

As the medium M, a sheet configured to include natural fibers or synthetic fibers, or a synthetic resin film or sheet can be used. For example, the medium M is paper, cloth, nonwoven fabric, or film. In the present embodiment, the configuration of the liquid ejection apparatus 11 using a long fabric wound in a roll shape as the medium M is exemplified, but other sheets can also be used as the medium M. The present disclosure is also applicable to an apparatus that uses, as the medium M, a sheet cut into a predetermined size.

The liquid ejection apparatus 11 of the present embodiment ejects ink, pretreatment liquid, and posttreatment liquid onto the medium M. The pretreatment liquid can also be called reaction liquid. The reaction solution includes a component that increases a viscosity of the ink and cures the ink by coming into contact with the ink. When the reaction liquid is mixed with the ink, the viscosity of the mixed liquid of the ink and the reaction liquid becomes higher than the viscosity of the ink, and the mixed liquid is cured. The posttreatment liquid is a material that coats the surface of the medium M in a state where at least any of the pretreatment liquid and the ink adheres to the medium M. The posttreatment liquid is ejected to, for example, the pretreatment liquid and the ink in an overlapping manner.

The ink used by the liquid ejection apparatus 11 is ink of white, black, and other colors, and may be liquid containing coloring pigment or a liquid in which a dye is dissolved. For example, the liquid ejection apparatus 11 can use ink of each color of white, black, cyan, magenta, yellow, red, green, and orange. The liquid ejection apparatus 11 can also use light color ink such as light cyan or light magenta, or neutral color ink. Each ink is what is called pigment ink containing water as a solvent and pigment as a pigment component. For example, white ink is ink containing a white pigment. Examples of the pigment include a white inorganic pigment. Specific examples thereof include sulfates of alkaline earth metals such as barium sulfate, carbonates of alkaline earth metals such as calcium carbonate, silicas such as fine powder silicic acid and synthetic silicates, metal compounds such as calcium silicate, alumina, alumina hydrate, titanium oxide, and zinc oxide, talc, and clay. Black ink is ink containing a black pigment, and contains a black inorganic pigment. Specifically, the black ink contains carbon black.

Of the ink used by the liquid ejection apparatus 11, ink of a color other than white ink and black ink is liquid containing an organic pigment as a dye component and not containing an inorganic pigment or having content of an inorganic pigment smaller than that of an organic pigment.

The liquid ejection apparatus 11 includes a pair of legs 12 and a housing 13 assembled on the legs 12. The liquid ejection apparatus 11 includes a delivery unit 15 configured to unwind and deliver the medium M wound in a roll shape, a guide unit 16 configured to guide the medium M discharged from the housing 13, and a recovery unit 17 configured to wind up and recover the medium M. The liquid ejection apparatus 11 includes a tension imparting mechanism 18 configured to impart tension to the medium M to be recovered by the recovery unit 17.

The liquid ejection apparatus 11 includes a liquid ejection unit 20 configured to eject liquid, a carriage 21 configured to move the liquid ejection unit 20, and a maintenance unit 22 configured to perform maintenance of the liquid ejection unit 20. The liquid ejection apparatus 11 includes a liquid supply apparatus 23 configured to supply liquid to the liquid ejection unit 20, and an operation panel 24 to be operated by a user. The carriage 21 reciprocates the liquid ejection unit 20 along the X axis. The liquid ejection unit 20 ejects and prints, on the medium M, liquid supplied through the liquid supply apparatus 23 while moving. The liquid ejection unit 20 is what is called a print head.

The liquid supply apparatus 23 includes a mount unit 26 removably mounted with a plurality of liquid accommodations 25 accommodating liquid, and a supply flow path 27 configured to supply liquid to the liquid ejection unit 20 from the liquid accommodations 25 mounted in the mounting unit 26.

The liquid ejection apparatus 11 includes a control unit 29 configured to control the operation of the liquid ejection apparatus 11. The control unit 29 is configured to include, for example, a processor such as a central processing unit (CPU) and a memory. The control unit 29 controls the liquid ejection unit 20, the liquid supply apparatus 23, the maintenance unit 22, and the like by the processor executing programs stored in the memory.

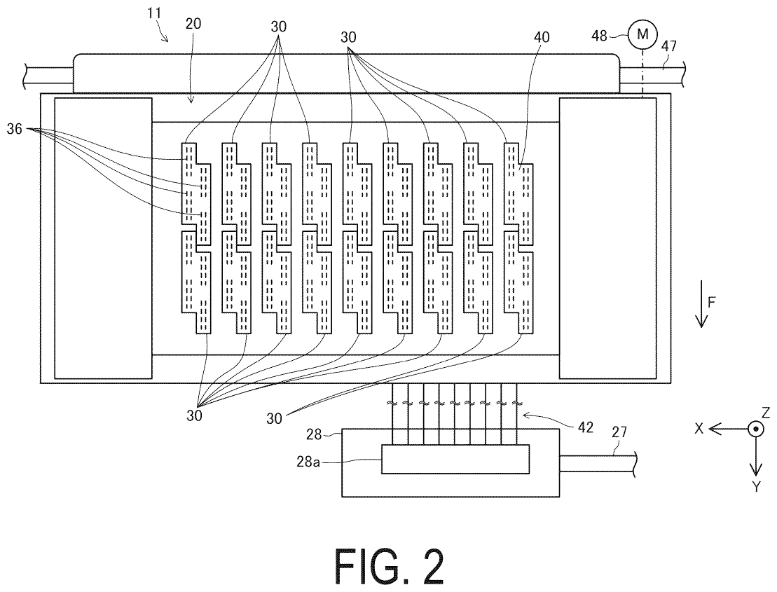

FIG. 2 is a bottom view of a main portion including the liquid ejection unit 20 and the carriage 21.

As illustrated in FIG. 2, the liquid ejection apparatus 11 includes a guide shaft 47 configured to support the carriage 21 and a carriage motor 48 configured to move the carriage 21. The guide shaft 47 extends in the width direction X. By controlling drive of the carriage motor 48, the control unit 29 reciprocates the carriage 21 and the liquid ejection unit 20 along the guide shaft 47. The carriage motor 48 can be called a movement mechanism, and the movement mechanism may include the carriage 21 and the guide shaft 47.

The liquid ejection unit 20 has a configuration in which a plurality of heads 30 are arranged in a body made of metal such as stainless steel. The heads 30 are supported by the body of the liquid ejection unit 20 and arranged side by side in a direction along the X axis and the Y axis. Nozzles of the heads 30 open on a nozzle surface 40 corresponding to a lower surface of the liquid ejection unit 20.

The nozzle surface 40 is covered with a liquid-repellent film that repels liquid such as ink.

The nozzle is an opening of a tube through which the liquid supplied from the liquid supply apparatus 23 through a supply flow path 27 passes, and ejects the liquid toward the medium M. In the heads 30, a large number of openings of the nozzles for ejecting liquid are arranged at regular intervals so as to form a row in the depth direction Y. The row of these nozzles constitutes a nozzle group 36. One head 30 includes, for example, four nozzle groups 36.

The liquid ejection unit 20 is coupled to a liquid flow mechanism 28. The liquid flow mechanism 28 is an apparatus configured to send, to the heads 30 of the liquid ejection unit 20, the liquid supplied from the liquid supply apparatus 23 through the supply flow path 27. The liquid flow mechanism 28 includes, for example, a pump, a pressure adjustment mechanism, and an on-off valve. The liquid flow mechanism 28 is coupled to each of the heads 30 via a supply flow path 42, and pumps, to the head 30, the liquid sent from the liquid supply apparatus 23.

The carriage 21 reciprocates along the guide shaft 47 by the power of the carriage motor 48. The movement direction of the medium M with respect to the liquid ejection unit 20, that is, a conveyance direction F is parallel to the Y axis as illustrated in FIG. 2, and is specifically the +Y direction. The liquid ejection unit 20 ejects liquid while moving in the width direction X with respect to the medium M together with the carriage 21.

### 2. Configuration of Maintenance Unit

One end portion of the movement range of the carriage 21 in the width direction X is provided with the maintenance unit 22. Now, the maintenance unit 22 will be described.

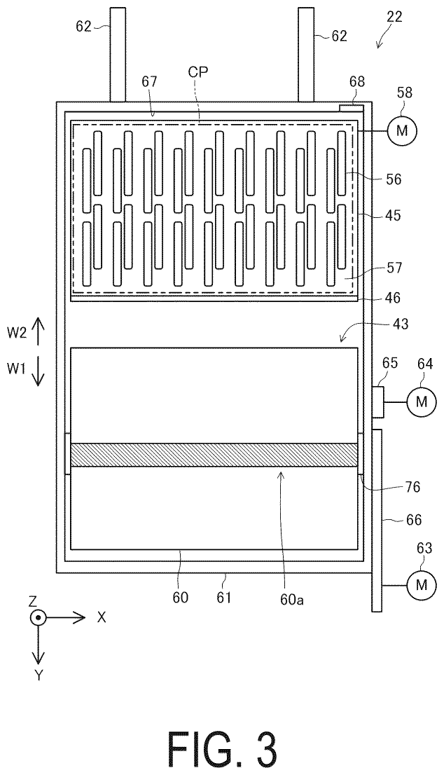

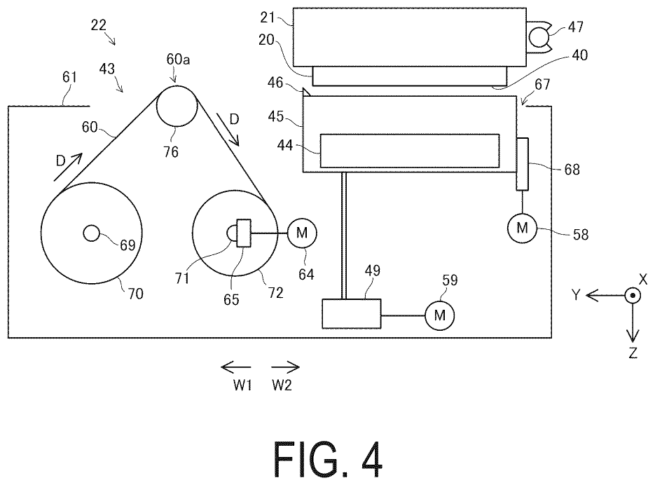

FIG. 3 is a plan view of the maintenance unit 22. FIGS. 4, 5, and 6 are side views of the maintenance unit 22.

As illustrated in FIG. 3, the maintenance unit 22 includes a case 61, a rail 62, a wiping motor 63, a wiping unit 43, and a capping apparatus 45.

The maintenance unit 22 is provided at one end portion of the movement range of the carriage 21 in the width direction X, and is at a position off from the region where the medium M is conveyed. When the carriage 21 moves to a position overlapping the maintenance unit 22 in the gravity direction Z, the liquid ejection unit 20 is positioned above the maintenance unit 22, enabling maintenance of the liquid ejection unit 20 by the maintenance unit 22. The upper side of the maintenance unit 22 can be called a home position of the liquid ejection unit 20. The home position is a start point of movement of the liquid ejection unit 20.

The case 61 is a housing configured to accommodate the wiping unit 43 and the capping apparatus 45. On the upper surface of the case 61, an exposure opening 67 for exposing the wiping member 60 and the capping apparatus 45 described later is opened. The capping apparatus 45 corresponds to an example of a cap portion.

The case 61 is coupled to the wiping motor 63 via a movement mechanism 66. The movement mechanism 66 includes, for example, a rack, a pinion gear, and a speed reducer, and reciprocates the case 61 along the Y axis on the rail 62 by the power of the wiping motor 63. When the wiping motor 63 is driven to rotate forward, the case 61 moves in a first wiping direction W1 parallel to the Y axis, and when the wiping motor 63 is driven to rotate backward, the case 61 moves in a second wiping direction W2 opposite to the first wiping direction W1. The depth direction Y is an example of the first direction, and one or both of the first wiping direction W1 and the second wiping direction W2 correspond to the first direction.

By moving the case 61, the liquid ejection unit 20 and the maintenance unit 22 relatively move in the depth direction Y. Then, the maintenance unit 22 transitions between a state where the wiping unit 43 faces the nozzle surface 40 and a state where the capping apparatus 45 faces the nozzle surface 40. In a state where the capping apparatus 45 faces the nozzle surface 40, a relative position of the liquid ejection unit 20 with respect to the capping apparatus 45 is called a cap position CP.

In FIG. 3, the cap position CP of the liquid ejection unit 20 is indicated by a two-dot chain line. The liquid ejection apparatus 11 has a configuration in which the liquid ejection unit 20 and the maintenance unit 22 move relative to each other in the depth direction Y. In the present embodiment, the liquid ejection unit 20 does not move in the depth direction Y, and the maintenance unit 22 moves in the depth direction Y. Therefore, the cap position CP in FIG. 3 indicates the position of the liquid ejection unit 20 when the liquid ejection unit 20 is positioned above the capping apparatus 45 as a result of movement of the maintenance unit 22.

As illustrated in FIGS. 3 and 4, the capping apparatus 45 includes a cap 56, a cap holder 57, a lifting mechanism 68 configured to reciprocate the cap holder 57 along the Z axis, and a cap motor 58 configured to drive the lifting mechanism 68. The lifting mechanism 68 moves the capping apparatus 45 in the gravity direction Z by the power of the cap motor 58. Due to this, the capping apparatus 45 ascends and descends. The capping apparatus 45 is at a position not in contact with the liquid ejection unit 20 in the gravity direction Z, and when capping the liquid ejection unit 20, ascends by the lifting mechanism 68 and comes into contact with the liquid ejection unit 20 positioned at the cap position CP. A position at which the capping apparatus 45 is separated from the liquid ejection unit 20 is a separation position.

The capping apparatus 45 includes a plurality of the caps 56. Each of the caps 56 is supported by the cap holder 57. In the present embodiment, the liquid ejection unit 20 includes 18 heads 30 and the two caps 56 correspond to each of the heads 30, and therefore 36 caps 56 are arranged in the capping apparatus 45. One cap 56 can cover the two nozzle groups 36 of the head 30.

The cap 56 has an edge having a substantially elliptical shape in plan view, an inner side of the edge is a recess portion, and a hole not illustrated opens in the bottom portion of the recess portion. The capping apparatus 45 is a container configured to store liquid without leakage, and when the liquid flows from the nozzle to the cap 56, the liquid accumulates in a bottom portion of the capping apparatus 45 through the hole of the cap 56. In the capping apparatus 45, an absorption member 44 is arranged below the cap 56. The absorption member 44 absorbs the liquid accumulating in the bottom portion of the capping apparatus 45 and prevents scattering of the liquid and the like. A suction pump 49 is coupled to the bottom portion of the capping apparatus 45 via a tube. A pump motor 59 configured to drive the suction pump 49 is coupled to the suction pump 49. The suction pump 49 sucks the liquid accumulating in the bottom portion of the capping apparatus 45 by the power of the pump motor 59. The pump motor 59 corresponds to an example of a drive source. As described later, when the wiping unit 43 and the capping apparatus 45 move in the depth direction Y, the pump motor 59 moves together with them and the suction pump 49.

The edge of the cap 56 is made of a flexible material and is in close contact with the nozzle surface 40. Therefore, in a state where the cap 56 is in contact with the nozzle surface 40, the nozzle opening on the nozzle surface 40 is tightly covered, and drying of the liquid adhering to the nozzle is prevented. In a state where the liquid ejection apparatus 11 is not performing printing, bringing the cap 56 into contact with the nozzle surface 40 is called standby capping, which is a part of maintenance. The standby capping suppresses evaporation of the liquid from the nozzle, and favorably maintains the state of the nozzle. When the suction pump 49 performs suction in a state where the cap 56 is in contact with the nozzle surface 40, negative pressure is generated inside the cap 56, and liquid can be sucked out from the nozzle to the cap 56.

An end portion of the capping apparatus 45 in the depth direction Y is provided a lip portion 46. The lip portion 46 is a member extending in the width direction X at the end portion of the capping apparatus 45 and protruding upward from the upper end of the capping apparatus 45. The lip portion 46 may be made of a flexible material or may be made of a rigid material.

The wiping unit 43 includes the wiping member 60 configured to absorb liquid. The wiping member 60 is an example of an absorption member having a sheet shape. The wiping member 60 is wound around an unwinding roller 70 and a winding shaft 71 arranged inside the case 61. The unwinding roller 70 is at a position closer to the +Y side in the case 61, and the wiping member 60 is accommodated in a state of being wound around the unwinding roller 70 and delivered from the unwinding roller 70. A winding roller 72 is positioned on the −Y side relative to the unwinding roller 70, and winds, into a roll shape, the wiping member 60 delivered from the unwinding roller 70. A press portion 76 is positioned between the unwinding roller 70 and the winding roller 72 in the depth direction Y and protrudes above the case 61. The unwinding roller 70 and the winding roller 72 correspond to examples of rollers.

The wiping member 60 is delivered from the unwinding roller 70, passes over the press portion 76, and is wound around the winding roller 72. An unwinding shaft 69, which is a center axis of the unwinding roller 70, is rotatably supported with respect to the case 61 with the X axis as an axial direction. The winding shaft 71, which is a center axis of the winding roller 72, is held by the case 61 with the X axis as an axial direction, and is coupled to a winding motor 64 via a power transmission mechanism 65. The power transmission mechanism 65 includes a speed reducer, and rotates the winding roller 72 by the drive force of the winding motor 64 to wind the wiping member 60 around the winding roller 72. Due to this, the part of the wiping member 60 unwound from the unwinding roller 70 moves in a direction D. The direction D is a direction along the conveyance path of the wiping member 60, and is a movement direction from the unwinding roller 70 that is upstream toward the winding roller 72 that is downstream.

The power transmission mechanism 65 may be configured to be disconnected from the winding shaft 71 along with the movement of the case 61. For example, the winding motor 64 and the winding shaft 71 may be coupled when the case 61 is at a position where wiping is performed on the nozzle surface 40 as described later, and the winding motor 64 and the winding shaft 71 may be separated when the case 61 is separated from this position.

The press portion 76 biases the wiping member 60 upward to protrude the wiping member 60 upward from the exposure opening 67. When the liquid ejection unit 20 passes a position overlapping the press portion 76 in the gravity direction Z, the wiping member 60 comes into contact with the nozzle surface 40. A position where the wiping member 60 comes into contact with the nozzle surface 40 is called a contact position 60a. The contact position 60a moves in the depth direction Y along the nozzle surface 40 as the liquid ejection unit 20 and the case 61 move relative to each other in the depth direction Y. Due to this, the nozzle surface 40 is wiped by the wiping member 60 having sucked the liquid.

### 3. Maintenance Operation

The liquid ejection apparatus 11 performs maintenance of the liquid ejection unit 20 using the maintenance unit 22. The maintenance includes flushing, suction cleaning, wiping, and pressurization cleaning. When wiping is performed subsequently to suction cleaning, wiping using the lip portion 46 can be performed. These maintenances will be described.

### 3-1. Flushing

Flushing is an operation of ejecting liquid from the nozzle of the liquid ejection unit 20, and has an effect of discharging liquid stored in the nozzle without being ejected for a predetermined time or more, for example, to restore fluidity. When flushing is performed, the liquid ejection apparatus 11 moves the carriage 21 such that the liquid ejection unit 20 is positioned above the maintenance unit 22, and moves the case 61 such that the capping apparatus 45 is positioned below the liquid ejection unit 20. The liquid ejection unit 20 ejects liquid in a state where the liquid ejection unit 20 is positioned at the cap position CP. At this time, the cap 56 may be in contact with the nozzle surface 40, or the cap 56 may be separated from the nozzle surface 40. Since the liquid accumulates in the capping apparatus 45 when flushing is performed, the liquid ejection apparatus 11 operates the pump motor 59 to suck the liquid by the suction pump 49 during or after performing the flushing.

### 3-2. Suction Cleaning

Suction cleaning is an operation of ejecting liquid from the nozzle of the liquid ejection unit 20 by the suction force of the suction pump 49, and by forcibly causing the liquid to outflow from the nozzle, the suction cleaning is expected to have an effect of eliminating slight clogging of the nozzle and an effect of removing the liquid with reduced fluidity inside the nozzle. The suction cleaning is performed in a state where the liquid ejection unit 20 is positioned at the cap position CP. When performing the suction cleaning, the liquid ejection apparatus 11 operates the cap motor 58 to bring the cap 56 of the capping apparatus 45 into contact with the nozzle surface 40, and operates the pump motor 59 to cause the suction pump 49 to perform suction. Due to this, negative pressure is generated inside the cap 56, and the liquid in the nozzle of the liquid ejection unit 20 is sucked out by the action of this negative pressure. The liquid discharged from the nozzle by the suction cleaning is received by the capping apparatus 45 and sucked by the suction pump 49.

### 3-3. Wiping

Wiping is maintenance of wiping the nozzle surface 40 by the wiping member 60.

The liquid ejection apparatus 11 operates the wiping motor 63 to move the case 61, and performs wiping on the liquid ejection unit 20 in at least one of a process in which the case 61 moves in the first wiping direction W1 and a process in which the case moves in the second wiping direction W2. In the present embodiment, the liquid ejection apparatus 11 performs wiping in the process of moving the wiping member 60 in the second wiping direction W2 with respect to the liquid ejection unit 20. That is, during wiping, the contact position 60a where the wiping member 60 is in contact with the liquid ejection unit 20 moves in the second wiping direction W2.

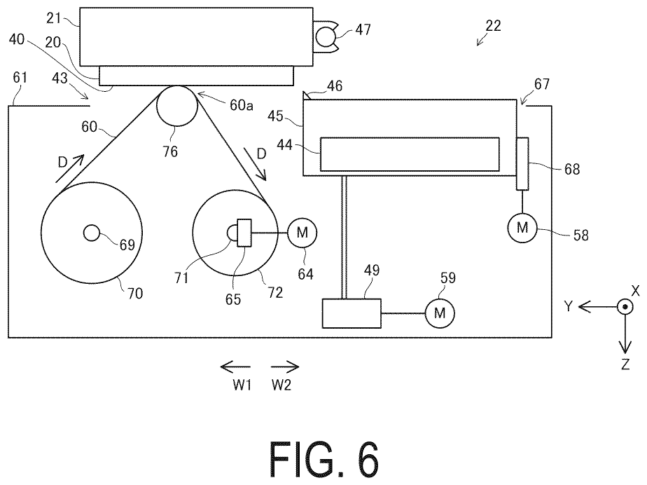

FIG. 6 illustrates the relative position of the maintenance unit 22 and the liquid ejection unit 20 during wiping. As illustrated in FIG. 6, the press portion 76 pushes up the wiping member 60 up to a position in contact with the nozzle surface 40. Therefore, by the case 61 moving in the second wiping direction W2, the wiping member 60 comes into contact with the nozzle surface 40 at the contact position 60a, and wipes the nozzle surface 40.

### 3-4. Wiping After Suction Cleaning

When wiping is performed after suction cleaning is performed, the position of the case 61 moves in the second wiping direction W2 from the position illustrated in FIG. 4 to the position illustrated in FIG. 6. In other words, the liquid ejection unit 20 relatively moves from the cap position CP to above the wiping unit 43. In this process, there is a possibility that the liquid adhering to the nozzle surface 40 drops or scatters between the capping apparatus 45 and the wiping unit 43. Therefore, the liquid ejection apparatus 11 of the present embodiment is provided with the lip portion 46 protruding upward from the capping apparatus 45, and can perform wiping by the lip portion 46.

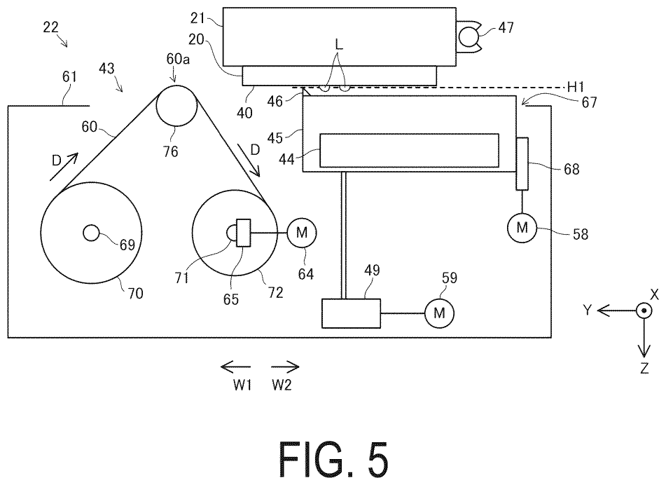

FIG. 5 illustrates a process in which the maintenance unit 22 transitions from the state illustrated in FIG. 4 to the state illustrated in FIG. 6. That is, the position of the liquid ejection unit 20 with respect to the case 61 is in a state of moving from the cap position CP to the upper side of the wiping unit 43. As illustrated in FIG. 5, after performing the suction cleaning, before moving the case 61 in the second wiping direction W2, the liquid ejection apparatus 11 operates the cap motor 58 to cause the capping apparatus 45 to ascend. At this time, the liquid ejection apparatus 11 causes the capping apparatus 45 to ascend to a position where a height position H1 of the upper end of the lip portion 46 does not reach the nozzle surface 40.

The height position H1 is lower than the nozzle surface 40. Furthermore, the height position H1 may be such a height as to come into contact with a droplet L adhering to the surface of the nozzle surface 40. When the case 61 moves in the second wiping direction W2 after the capping apparatus 45 is caused to ascend, the droplet L adhering to the nozzle surface 40 is scraped off by the lip portion 46 and flows to the capping apparatus 45. This prevents the droplet L adhering to the nozzle surface 40 from dropping or scattering during movement of the case 61.

The lip portion 46 may protrude upward at the end portion of the capping apparatus 45, and may have a size enough to straddle substantially the entire nozzle surface 40 in the width direction X or at least a range provided with the nozzle group 36. The shape of the lip portion 46 in side view is discretionary. For example, as illustrated in FIGS. 4 to 6, the lip portion 46 may be configured to have an inclined surface directed to the inside of the capping apparatus 45 in side view, and guide the droplet L to the inside of the capping apparatus 45. The lip portion 46 needs not be positioned at the outermost end of the capping apparatus 45.

Also when performing wiping by the wiping unit 43 after flushing, the liquid ejection apparatus 11 may also perform wiping by the lip portion 46 in the same manner as described above. Also when performing wiping by the wiping unit 43 after performing the pressurization cleaning described later, the liquid ejection apparatus 11 may also perform wiping by the lip portion 46 in the same manner as described above.

### 3-5. Pressurization Cleaning

The pressurization cleaning is an operation of ejecting liquid from the nozzle of the liquid ejection unit 20 by the pressure at which a pressurization mechanism 28a pumps the liquid, and is expected to have an effect similar to that of the suction cleaning. The pressurization cleaning is performed in a state where the liquid ejection unit 20 is positioned at the cap position CP. When performing the pressurization cleaning, the liquid ejection apparatus 11 operates the cap motor 58 to bring the cap 56 of the capping apparatus 45 into contact with the nozzle surface 40 or bring the capping apparatus 45 into a state of being close to the nozzle surface 40.

The liquid ejection apparatus 11 operates the pressurization mechanism 28a to pump liquid from the liquid flow mechanism 28 to the heads 30. This pressure discharges the liquid from the nozzle. The liquid discharged from the nozzle by the pressurization cleaning is received by the capping apparatus 45 and sucked by the suction pump 49.

### 4. Control System of Liquid Ejection Apparatus

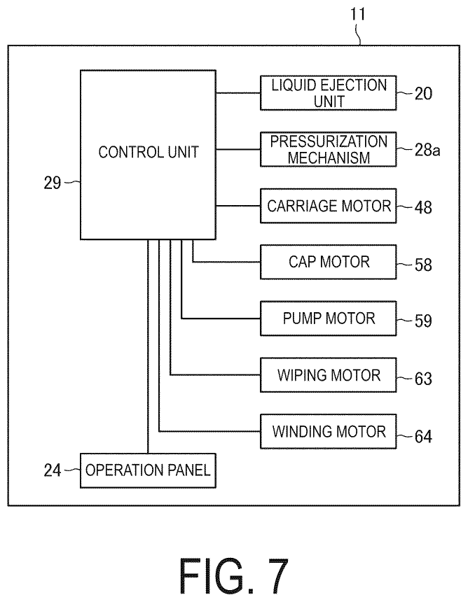

FIG. 7 is a block diagram illustrating the configuration of the control system of the liquid ejection apparatus 11.

As illustrated in FIG. 7, the control unit 29 is coupled to the liquid ejection unit 20, the operation panel 24, the pressurization mechanism 28a, the carriage motor 48, the cap motor 58, the pump motor 59, the wiping motor 63, and the winding motor 64.

The configuration illustrated in FIG. 7 is a main portion of the liquid ejection apparatus 11, and a functional unit, a motor, a sensor, or other devices not illustrated in FIG. 7 may be coupled to the control unit 29. For example, the liquid ejection apparatus 11 may include a sensor configured to detect or count the position of the carriage 21 in the width direction X, the position of the case 61 in the depth direction Y, the height of the capping apparatus 45, the winding amount of the wiping member 60 wound by the winding roller 72, and the like. These sensors may be coupled to the control unit 29, and the control unit 29 may control each unit in FIG. 7 based on a detection value of each sensor.

The control unit 29 controls the pressurization mechanism 28a to send, to the liquid ejection unit 20, the liquid supplied via the supply flow path 27. The control unit 29 controls the liquid ejection unit 20 to eject, from the nozzle, the liquid supplied from the liquid flow mechanism 28.

By operating the carriage motor 48, the control unit 29 moves the carriage 21 in the width direction X. By operating the cap motor 58, the control unit 29 moves the capping apparatus 45 in the gravity direction Z. By operating the pump motor 59, the control unit 29 drives the suction pump 49 to suck the liquid of the capping apparatus 45. By operating the wiping motor 63, the control unit 29 moves the case 61 in the first wiping direction W1 and the second wiping direction W2. By operating the winding motor 64, the control unit 29 delivers and winds, around the winding roller 72, the wiping member 60 from the unwinding roller 70.

The control unit 29 causes the operation panel 24 to display the operating state and the like of the liquid ejection apparatus 11.

### 5. Operation Example of Liquid Ejection Apparatus

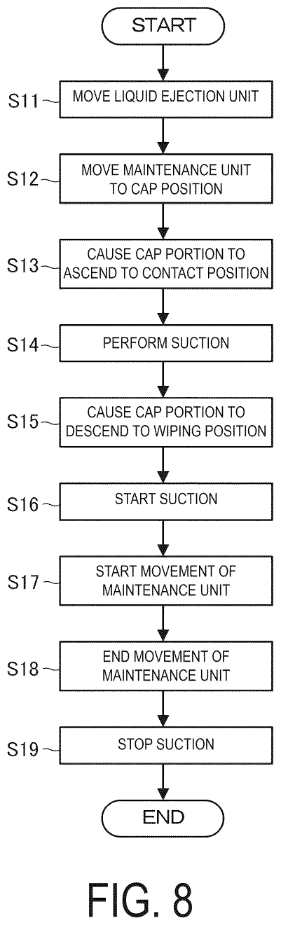

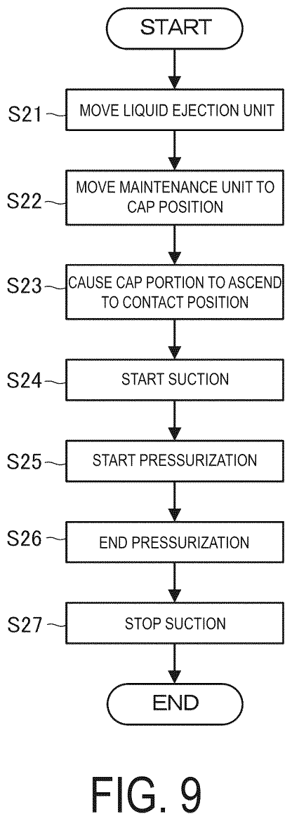

FIGS. 8 and 9 are flowcharts showing the operation of the liquid ejection apparatus 11. FIG. 8 shows the operation of the liquid ejection apparatus 11 when continuously performing suction cleaning and wiping by the wiping unit 43. FIG. 9 shows the operation of the liquid ejection apparatus 11 in pressurization cleaning. An operation example of the liquid ejection apparatus 11 will be described with reference to these drawings. The operations in FIGS. 8 and 9 are executed under the control of the control unit 29.

The liquid ejection apparatus 11 operates the carriage motor 48 to move the carriage 21 in the width direction X (step S11). Specifically, the liquid ejection apparatus 11 moves the carriage 21 to a position where the liquid ejection unit 20 overlaps the maintenance unit 22 in the width direction X.

Subsequently, the liquid ejection apparatus 11 operates the wiping motor 63 to move the case 61 (step S12).

Specifically, the liquid ejection apparatus 11 moves the case 61 until the capping apparatus 45 of the maintenance unit 22 is positioned below the liquid ejection unit 20. Due to this, the liquid ejection unit 20 is positioned at the cap position CP.

The liquid ejection apparatus 11 operates the cap motor 58 to cause the capping apparatus 45 to ascend to the contact position (step S13). The contact position is a position of the capping apparatus 45 in the gravity direction Z, and is a height at which the cap 56 comes into contact with or crimps the nozzle surface 40.

After the ascending of the capping apparatus 45 is completed, the liquid ejection apparatus 11 operates the pump motor 59 to perform suction by the suction pump 49 (step S14). This discharges the liquid from the nozzle of the nozzle surface 40.

After stopping the suction in step S14, the liquid ejection apparatus 11 operates the cap motor 58 to descend the capping apparatus 45 to a wiping position (step S15). The wiping position is a position of the capping apparatus 45 in the gravity direction Z, and is a height at which the cap 56 is separated from the nozzle surface 40. The wiping position is a position where the lip portion 46 comes into contact with the droplet L adhering to the nozzle surface 40. That is, the height of the upper end of the lip portion 46 at the wiping position is the height position H1.

After causing the capping apparatus 45 to descend to the wiping position, the liquid ejection apparatus 11 starts suction by the suction pump 49 (step S16). Then, the liquid ejection apparatus 11 starts movement of the case 61 while the suction pump 49 is performing suction (step S17). In step S17, the wiping motor 63 is operated to start the movement of the case 61 in the second wiping direction W2.

After the liquid ejection unit 20 moves above the wiping unit 43 and the wiping of the nozzle surface 40 by the wiping member 60 is completed, the liquid ejection apparatus 11 stops the wiping motor 63 to end the movement of the case 61 (step S18). The liquid ejection apparatus 11 stops the pump motor 59 to stop suction by the suction pump 49 (step S19).

The timing at which the liquid ejection apparatus 11 stops suction by the suction pump 49 may be before step S18. For example, the liquid ejection apparatus 11 may stop the suction pump 49 at a discretionary timing after the lip portion 46 reaches the end portion on the −Y side of the nozzle surface 40.

According to the operation of FIG. 8, suction cleaning of the liquid ejection unit 20 and wiping by the wiping member 60 can be continuously performed. Then, while the case 61 is being moved after the suction cleaning is completed, the droplet L adhering to the nozzle surface 40 is received in the capping apparatus 45 by the lip portion 46. This enables the suction cleaning and the wiping to be continuously performed without dropping or scattering the droplet L outside the capping apparatus 45.

As described above, the operation of FIG. 8 is also applicable to a case of continuously performing flushing and wiping by the wiping member 60, and a case of continuously performing pressurization cleaning and wiping by the wiping member 60.

Next, the pressurization cleaning will be described. The liquid ejection apparatus 11 operates the carriage motor 48 to move the carriage 21 to the position where the liquid ejection unit 20 overlaps the maintenance unit 22 in the width direction X (step S21).

Subsequently, the liquid ejection apparatus 11 operates the wiping motor 63 to move the case 61 until the capping apparatus 45 of the maintenance unit 22 is positioned below the liquid ejection unit 20 (step S22). Due to this, the liquid ejection unit 20 is positioned at the cap position CP.

The liquid ejection apparatus 11 operates the cap motor 58 to cause the capping apparatus 45 to ascend to the contact position (step S23).

After the ascending of the capping apparatus 45 is completed, the liquid ejection apparatus 11 operates the pump motor 59 to perform suction by the suction pump 49 (step S24). Subsequently, the liquid ejection apparatus 11 operates the pressurization mechanism 28a to start pressurization (step S25). This starts pumping of the liquid from the liquid flow mechanism 28 to the heads 30.

The liquid ejection apparatus 11 stops the pressurization mechanism 28a after a predetermined time has elapsed from the start of pressurization, and ends the pressurization (step S26). This stops the pumping of the liquid to the heads 30. Thereafter, the liquid ejection apparatus 11 stops the pump motor 59 to stop suction of the suction pump 49 (step S27).

According to the operation of FIG. 9, the pressurization cleaning of pumping the liquid from the liquid flow mechanism 28 to the liquid ejection unit 20 is performed, and the liquid discharged from the nozzle in the pressurization cleaning is received and sucked by the capping apparatus 45. This enables the pressurization cleaning to be performed without leaking the liquid to the outside of the capping apparatus 45.

The liquid ejection apparatus 11 may perform wiping by the wiping unit 43 after the pressurization cleaning. In this case, the liquid ejection apparatus 11 may perform the operations of steps S15 to S19 of FIG. 8 subsequent to step S27 of FIG. 9.

6. Effects and the like

As described above, the liquid ejection apparatus 11 of the present disclosure includes the liquid ejection unit 20 including the nozzle surface 40 in which the nozzle opens, the liquid ejection unit eject liquid from the nozzle, and the capping apparatus 45 configured to receive liquid discharged from the liquid ejection unit 20. The liquid ejection apparatus 11 includes the suction pump 49 configured to suck liquid inside the capping apparatus 45, and the wiping unit 43 configured to wipe the nozzle surface 40 by moving in the depth direction Y with respect to the liquid ejection unit 20 together with the capping apparatus 45 and the suction pump 49.

This enables the operation of sucking liquid from the nozzle of the liquid ejection unit 20 and discharging the liquid to the cap and the wiping to be executed without moving the liquid ejection unit. This prevents or reduces dropping or scattering of liquid from the nozzle surface 40 to the outside of the cap in the maintenance of the liquid ejection unit 20.

By the suction pump 49 performing suction, the liquid ejection apparatus 11 sucks liquid from the liquid ejection unit 20 in a state where the capping apparatus 45 covers the nozzle surface 40.

According to this, maintenance of the nozzle is performed by sucking the liquid from the nozzle by the negative pressure of the suction pump 49.

The liquid ejection apparatus 11 further includes the pressurization mechanism 28a configured to discharge liquid from the liquid ejection unit 20 by pumping liquid to the liquid ejection unit 20. The liquid ejection apparatus 11 can suck, by the suction pump 49, the liquid discharged from the liquid ejection unit 20 to the capping apparatus 45 by pumping of the pressurization mechanism 28a.

This enables maintenance of the nozzle to be performed by pumping liquid from the liquid flow mechanism 28. Since cleaning by suction and pressurization cleaning are performed by using the capping apparatus 45, downsizing of the maintenance unit 22 is achieved.

The wiping unit 43 includes the wiping member 60 configured to absorb liquid, and the unwinding roller 70 around which the wiping member 60 is wound, and the winding roller 72.

This efficiently wipes off liquid adhering to the nozzle surface 40.

The capping apparatus 45 includes the lip portion 46 protruding toward the nozzle surface 40. In the liquid ejection apparatus 11, the lip portion 46 comes into contact with the liquid adhering to the nozzle surface 40 while the capping apparatus 45 and the wiping unit 43 are moving in the depth direction Y.

This prevents or reduces the liquid from dropping or scattering from the nozzle surface 40 to the outside of the capping apparatus 45 while the maintenance unit 22 is moving. By the lip portion 46 scraping off the droplet L adhering to the nozzle surface 40, the liquid to be absorbed by the wiping member 60 is reduced.

In the above configuration, the capping apparatus 45 and the wiping unit 43 move in the depth direction Y in a state where the lip portion 46 is in contact with the liquid adhering to the nozzle surface 40 and the lip portion 46 is not in contact with the nozzle surface 40.

This scrapes off the droplet L adhering to the nozzle surface 40 in a state where the lip portion 46 is not in contact with the nozzle surface 40. Therefore, dirt and the like adhering to the lip portion 46 are prevented from adhering to the nozzle surface 40.

In the above configuration, the suction pump 49 sucks the liquid inside the capping apparatus 45 while the liquid is discharged to the capping apparatus 45 by the pressurization mechanism 28a.

This performs the suction cleaning without causing the liquid received by the capping apparatus 45 to overflow from the capping apparatus 45.

The capping apparatus 45 includes the absorption member 44 configured to absorb liquid received from the liquid ejection unit 20.

This increases the amount of liquid receivable by the capping apparatus 45.

The liquid ejection apparatus 11 further includes the pump motor 59 configured to drive the suction pump 49. The pump motor 59 moves in the depth direction Y together with the capping apparatus 45, the suction pump 49, and the wiping unit

43.

According to this, since the pump motor 59 moves together with the suction pump 49, the coupling structure between the pump motor 59 and the suction pump 49 is simplified, and power transmission from the pump motor 59 to the suction pump 49 becomes easy.

The maintenance unit 22 is the maintenance unit 22 configured to maintain the liquid ejection apparatus 11 including the nozzle surface 40 in which the nozzle opens, the liquid ejection apparatus 11 including the liquid ejection unit 20 configured to eject liquid from the nozzle. The maintenance unit 22 includes the capping apparatus 45 configured to receive the liquid discharged from the liquid ejection unit 20, and the suction pump 49 configured to suck the liquid inside the capping apparatus 45. The maintenance unit 22 includes the wiping unit 43 configured to wipe the nozzle surface 40 by moving in the depth direction Y together with the capping apparatus 45 and the suction pump 49.

This enables the operation of sucking liquid from the nozzle of the liquid ejection unit 20 and discharging the liquid to the cap and the wiping to be executed without moving the liquid ejection unit. This prevents or reduces dropping or scattering of liquid from the nozzle surface 40 to the outside of the cap in the maintenance of the liquid ejection unit 20.

The maintenance unit 22 further includes the pump motor 59 configured to drive the suction pump 49. The pump motor 59 moves in the depth direction Y together with the capping apparatus 45, the suction pump 49, and the wiping unit 43.

According to this, since the pump motor 59 moves together with the suction pump 49, the coupling structure between the pump motor 59 and the suction pump 49 is simplified, and power transmission from the pump motor 59 to the suction pump 49 becomes easy.

A maintenance method of the liquid ejection unit 20 including the nozzle surface 40 in which the nozzle opens, the liquid ejection unit 20 configured to eject liquid from the nozzle, includes discharging liquid from the liquid ejection unit 20 to the capping apparatus 45 configured to receive the liquid. The maintenance method includes, together with the capping apparatus 45, moving, in the depth direction Y, the suction pump 49 configured to suck liquid from the capping apparatus 45 and the wiping unit 43, and wiping the nozzle surface 40 by the wiping unit 43. The maintenance method includes sucking the liquid discharged to the capping apparatus 45 by the suction pump 49.

This enables the operation of sucking liquid from the nozzle of the liquid ejection unit 20 and discharging the liquid to the cap and the wiping to be executed without moving the liquid ejection unit. This prevents or reduces dropping or scattering of liquid from the nozzle surface 40 to the outside of the cap in the maintenance of the liquid ejection unit 20.

The maintenance method includes moving the capping apparatus 45 toward the nozzle surface 40 to bring the capping apparatus 45 into contact with the nozzle surface 40. The maintenance method includes operating the suction pump 49 in a state where the capping apparatus 45 is in contact with the nozzle surface 40 to eject liquid from the liquid ejection unit 20.

According to this, maintenance of the nozzle is performed by sucking the liquid from the nozzle by the negative pressure of the suction pump 49.

The maintenance method includes ejecting liquid from the liquid ejection unit 20 to the capping apparatus 45 by pumping liquid to the liquid ejection unit 20.

This enables maintenance of the nozzle to be performed by pumping liquid to the nozzle. Since cleaning by suction and pressurization cleaning are performed by using the capping apparatus 45, downsizing of the maintenance unit 22 is achieved.

The maintenance method includes operating the suction pump 49 to suck liquid from the capping apparatus 45 while ejecting liquid from the liquid ejection unit 20 to the capping apparatus 45 by pumping liquid to the liquid ejection unit 20.

This enables the liquid received by the capping apparatus 45 to be quickly sucked in maintenance of pumping the liquid to the nozzle. Therefore, more liquid can be ejected in maintenance.

### 7. Other Embodiments

The above embodiment merely shows a specific example applied with the present disclosure. The present disclosure is not limited to the configuration of the above embodiment, and can be implemented in various aspects without departing from the gist of the disclosure.

In the above embodiment, the maintenance unit 22 has been described as a configuration in which the nozzle surface 40 is wiped by the wiping member 60 while the case 61 is moving in the second wiping direction W2, but this is an example. For example, the maintenance unit 22 may be configured to perform wiping while the case 61 moves in the first wiping direction W1.

In the above embodiment, a cleaning liquid for cleaning may be used as the liquid to be supplied from the liquid flow mechanism 28 to the heads 30 during the suction cleaning and the pressurization cleaning.

The liquid ejection apparatus 11 may be a liquid ejection apparatus configured to eject or jet liquid other than ink. The state of the liquid ejected from the liquid ejection apparatus in a form of a minute amount of droplet is assumed to include a particulate form, a teardrop form, and a thread like extending form. The liquid mentioned here may be any material that can be ejected from the liquid ejection apparatus. For example, the liquid may be any material in a state of being in a liquid phase, and is assumed to include a liquid body having high or low viscosity, as well as a fluid body such as sol, gel water, other inorganic solvents, an organic solvent, a solution, a liquid resin, a liquid metal, and a metal melt. The liquid includes not only liquid as a single state of the substance, but also includes particles of a functional material made of a solid such as pigment or metal particles, the particles being dissolved, dispersed or mixed in a solvent, and the like. Typical examples of the liquid include ink and liquid crystal as described in the above embodiment. The ink here includes general aqueous ink and solvent ink, and various liquid compositions such as gel ink and hot-melt ink. Examples of the liquid ejection apparatus include an apparatus configured to eject liquid including, in a dispersed or dissolved form, a material such as an electrode material and a color material used in manufacture of liquid crystal displays, electroluminescent displays, surface emitting displays, color filters, and the like. The liquid ejection apparatus may be an apparatus configured to eject bioorganic substances used for biochip manufacturing, an apparatus used as a precision pipette and ejecting liquid to be a sample, a printing apparatus, a micro dispenser, or the like. The liquid ejection apparatus may be an apparatus configured to eject lubricant to a precision machine such as a clock or a camera in a pinpoint manner, or an apparatus configured to eject, on a substrate, transparent resin liquid such as ultraviolet cure resin or the like for forming a tiny hemispherical lens, optical lens, or the like used for an optical communication element and the like. The liquid ejection apparatus may be an apparatus configured to etching liquid such as acid or alkali for etching a substrate or the like.

In the above embodiment, the configuration in which the liquid ejection unit 20 includes the 18 heads 30 has been described, but the number of heads 30 mounted on the liquid ejection unit 20 is not limited.

In addition, the configurations relating to the conveyance of the maintenance unit 22 and the medium M described in the above embodiment are not limited, and various configurations can be adopted.

### 8. Configuration Described in Embodiment

The following configurations will be described based on the above-described embodiment.

### Configuration 1

A liquid ejection apparatus including a liquid ejection unit including a nozzle surface in which a nozzle opens, the liquid ejection unit configured to eject liquid from the nozzle a cap portion configured to receive liquid discharged from the liquid ejection unit a suction pump configured to suck liquid inside the cap portion, and a wiping unit configured to wipe the nozzle surface by moving in a first direction together with the cap portion and the suction pump.

This enables the operation of sucking liquid from the nozzle of the liquid ejection unit and discharging the liquid to the cap and the wiping to be executed without moving the liquid ejection unit. This can prevent or reduce dropping or scattering of liquid from the nozzle surface to the outside of the cap in maintenance of the liquid ejection unit.

### Configuration 2

The liquid ejection apparatus according to configuration 1, in which by performing suction, the suction pump sucks liquid from the liquid ejection unit in a state where the cap portion covers the nozzle surface.

According to this, maintenance of the nozzle is performed by sucking the liquid from the nozzle by the negative pressure of the suction pump.

### Configuration 3

The liquid ejection apparatus according to configuration 2, further including a pressurization mechanism configured to eject liquid from the liquid ejection unit by pumping liquid to the liquid ejection unit, in which the suction pump sucks liquid discharged from the liquid ejection unit to the cap portion by pumping of the pressurization mechanism.

This enables maintenance of the nozzle to be performed by pumping liquid from the liquid flow mechanism. Since cleaning by suction and pressurization cleaning are performed by using the cap portion, downsizing of the mechanism related to maintenance is achieved.

### Configuration 4

The liquid ejection apparatus according to any of configurations 1 to 3, in which the wiping unit includes a wiping member configured to absorb liquid, and a roller around which the wiping member is wound.

This efficiently wipes off liquid adhering to the nozzle surface.

### Configuration 5

The liquid ejection apparatus according to configuration 4, in which the cap portion includes a lip portion protruding toward the nozzle surface, and the lip portion comes into contact with liquid adhering to the nozzle surface while the cap portion and the wiping unit move in the first direction.

This prevents or reduces the liquid from dropping or scattering from the nozzle surface to the outside of the cap portion while the cap portion and the wiping move. By the lip portion scraping off the liquid adhering to the nozzle surface, the liquid to be wiped by the wiping member is reduced.

### Configuration 6

The liquid ejection apparatus according to configuration 5, in which the cap portion and the wiping unit move in the first direction in a state where the lip portion is in contact with liquid adhering to the nozzle surface and the lip portion is not in contact with the nozzle surface.

This scrape off the liquid adhering to the nozzle surface in a state where the lip portion is not in contact with the nozzle surface. Therefore, dirt and the like adhering to the lip portion are prevented from adhering to the nozzle surface.

### Configuration 7

The liquid ejection apparatus according to configuration 3, in which the suction pump sucks liquid inside the cap portion while the pressurization mechanism discharges liquid to the cap portion.

This performs maintenance of the nozzle by sucking the liquid from the nozzle without causing the liquid received by the cap portion to overflow from the cap portion.

### Configuration 8

The liquid ejection apparatus according to any of configurations 1 to 7, in which the cap portion includes an absorption member configured to absorb liquid received from the liquid ejection unit.

This increases the amount of liquid receivable by the cap portion.

### Configuration 9

The liquid ejection apparatus according to any of configurations 1 to 8, further including a drive source configured to drive the suction pump, in which the drive source moves in the first direction together with the cap portion, the suction pump, and the wiping unit.

According to this, since the drive source of the suction pump moves together with the suction pump, the coupling structure between the drive source and the suction pump is simplified, and power transmission from the drive source to the suction pump becomes easy.

### Configuration 10

A maintenance unit configured to maintain a liquid ejection apparatus including a liquid ejection unit including a nozzle surface in which a nozzle opens, the liquid ejection unit configured to eject liquid from the nozzle, the maintenance unit including a cap portion configured to receive liquid discharged from the liquid ejection unit, a suction pump configured to suck liquid inside the cap portion, and a wiping unit configured to wipe the nozzle surface by moving in a first direction together with the cap portion and the suction pump.

This achieves an effect similar to that of configuration 1.

### Configuration 11

The maintenance unit according to configuration 10, further including a drive source configured to drive the suction pump, in which the drive source moves in one direction together with the cap portion, the suction pump, and the wiping unit. This achieves an effect similar to that of configuration 9.

### Configuration 12

A maintenance method for a liquid ejection unit including a nozzle surface in which a nozzle opens, the liquid ejection unit configured to eject liquid from the nozzle, the maintenance method including discharging liquid from the liquid ejection unit to a cap portion configured to receive liquid, wiping, by the wiping unit, the nozzle surface by moving, together with the cap portion, a suction pump configured to suck liquid from the cap portion, and a wiping unit in a first direction, and sucking liquid discharged to the cap portion by the suction pump.

This achieves an effect similar to that of configuration 1.

### Configuration 13

The maintenance method according to configuration 12, further including moving the cap portion toward the nozzle surface to bring the cap portion into contact with the nozzle surface, and ejecting liquid from the liquid ejection unit by operating the suction pump in a state where the cap portion is in contact with the nozzle surface.

According to this, maintenance of the nozzle is performed by sucking the liquid from the nozzle by the negative pressure of the suction pump.

### Configuration 14

The maintenance method according to configuration 13, further including ejecting liquid from the liquid ejection unit to the cap portion by pumping liquid to the liquid ejection unit.

This enables maintenance of the nozzle to be performed by pumping liquid to the nozzle. Since cleaning by suction and pressurization cleaning are performed by using the cap portion, downsizing of the mechanism related to maintenance is achieved.

### Configuration 15

The maintenance method according to configuration 14, further including operating the suction pump to suck liquid from the cap portion while ejecting liquid from the liquid ejection unit to the cap portion by pumping liquid to the liquid ejection unit.

This enables the liquid received by the cap portion to be quickly sucked in maintenance of pumping the liquid to the nozzle. Therefore, more liquid can be ejected in maintenance.

What is claimed is:

1. A liquid ejection apparatus comprising:
a liquid ejection unit including a nozzle surface in which a nozzle opens, the liquid ejection unit configured to eject liquid from the nozzle;
a cap portion configured to receive liquid discharged from the liquid ejection unit;
a suction pump configured to suck liquid inside the cap portion; and
a wiping unit configured to wipe the nozzle surface by moving in a first direction together with the cap portion and the suction pump.

2. The liquid ejection apparatus according to claim 1, wherein by performing suction, the suction pump is configured to suck liquid from the liquid ejection unit in a state where the cap portion covers the nozzle surface.

3. The liquid ejection apparatus according to claim 2, further comprising:
a pressurization mechanism configured to eject liquid from the liquid ejection unit by pumping liquid to the liquid ejection unit, wherein
the suction pump is configured to suck, by pumping of the pressurization mechanism, liquid discharged from the liquid ejection unit to the cap portion.

4. The liquid ejection apparatus according to claim 1, wherein the wiping unit includes a wiping member configured to absorb liquid, and a roller around which the wiping member is wound.

5. The liquid ejection apparatus according to claim 4, wherein
the cap portion includes a lip portion protruding toward the nozzle surface, and
the lip portion comes into contact with liquid adhering to the nozzle surface while the cap portion and the wiping unit move in the first direction.

6. The liquid ejection apparatus according to claim 5, wherein the cap portion and the wiping unit move in the first direction in a state where the lip portion is in contact with liquid adhering to the nozzle surface and the lip portion is not in contact with the nozzle surface.

7. The liquid ejection apparatus according to claim 3, wherein the suction pump sucks liquid inside the cap portion while the pressurization mechanism discharges liquid to the cap portion.

8. The liquid ejection apparatus according to claim 1, wherein the cap portion includes an absorption member configured to absorb liquid received from the liquid ejection unit.

9. The liquid ejection apparatus according to claim 1, further comprising:
a drive source configured to drive the suction pump, wherein
the drive source moves in the first direction together with the cap portion, the suction pump, and the wiping unit.

10. A maintenance unit configured to maintain a liquid ejection apparatus including a liquid ejection unit including a nozzle surface in which a nozzle opens, the liquid ejection unit configured to eject liquid from the nozzle, the maintenance unit comprising:
a cap portion configured to receive liquid discharged from the liquid ejection unit;
a suction pump configured to suck liquid inside the cap portion; and
a wiping unit configured to wipe the nozzle surface by moving in a first direction together with the cap portion and the suction pump.

11. The maintenance unit according to claim 10, further comprising:
a drive source configured to drive the suction pump, wherein
the drive source moves in one direction together with the cap portion, the suction pump, and the wiping unit.

12. A maintenance method for a liquid ejection unit including a nozzle surface in which a nozzle opens, the liquid ejection unit configured to eject liquid from the nozzle, the maintenance method comprising:
discharging liquid from the liquid ejection unit to a cap portion configured to receive liquid;
wiping, by the wiping unit, the nozzle surface by moving, together with the cap portion, a suction pump configured to suck liquid from the cap portion, and a wiping unit in a first direction; and
sucking liquid discharged to the cap portion by the suction pump.

13. The maintenance method according to claim 12, further comprising:
moving the cap portion toward the nozzle surface to bring the cap portion into contact with the nozzle surface; and
ejecting liquid from the liquid ejection unit by operating the suction pump in a state where the cap portion is in contact with the nozzle surface.

14. The maintenance method according to claim 13, further comprising ejecting liquid from the liquid ejection unit to the cap portion by pumping liquid to the liquid ejection unit.

15. The maintenance method according to claim 14, further comprising operating the suction pump to suck liquid from the cap portion while ejecting liquid from the liquid ejection unit to the cap portion by pumping liquid to the liquid ejection unit.
